(19) United States
(12) Patent Application Publication
(10) Pub. No.: US 2010/0305931 A1
(43) Pub. Date: Dec. 2, 2010

(54) WIRELESS NETWORK DESIGN SIMULATION PACKAGE

(76) Inventor: BRADLEY S. FORDHAM, Atlanta, GA (US)

Correspondence Address: SMITH FROHWEIN TEMPEL GREENLEE BLAHA, LLC, Two Ravinia Drive, Suite 700, ATLANTA, GA, 30346, US

(21) Appl. No.: 12/473,332

(22) Filed: May 28, 2009

(51) Int. Cl. G06G 7/62; G06F 17/50; G06N 7/06

(52) U.S. Cl. 703/13; 706/52

(57) ABSTRACT

A system and method to automate the design and optimization of a wireless telecommunications network is disclosed. More specifically, the disclosed invention provides the functionality to quickly and easily simulate configurations for various wireless telecommunications network components at predetermined geographical locations in order to predict performance of potential wireless network links. The invention is also operable to optimize network component configurations and locations to predict optimum network footprints. To transform data associated with predetermined geographical network link locations and wireless network component performance specifications, the present invention employs a series of specialized algorithms and editors, to compile and simulate user provided configurations of all key aspects of each wireless link in a theoretical network footprint. Once each wireless link, or network node, is configured by the relevant editor, the invention simulates and predicts network performance via a simulation engine before providing the user with a representative output.

### BACKGROUND

The various embodiments presented in this disclosure relate generally to design and planning simulation software and, more particularly, to simulation software applicable for wireless network design and optimization.

In general, simulation software for various applications has been around in the industry for quite some time. Engineers and planners make use of simulation packages every day as they go about designing the processes, methods, systems, and products that make up our ever evolving world of technology. Process engineers employed by numerous engineering firms and companies across the world are sitting in cubicles right now plugging and chugging with process simulation packages in an effort to predict the viability of industrial processes. Civil engineers are somewhere right now, no doubt, using finite element analysis software in order to identify failure modes and load limitations of structures ranging from skyscrapers to bridges. Mechanical engineers are constantly using sizing software to select and specify process components like pumps, valves, piping, and even things as mundane as bearing packs and grease types. Industrial and systems engineers are forever tweaking processes and logistical systems with specialized simulation software. Even designers of the more aesthetic type, such as architects, often rely on simulation software in order to quickly generate renderings of their concepts.

Simulation software is, most definitely, a useful and indispensible tool for any engineer or designer fortunate enough to have access to a program specifically designed for the task at hand. “Back in the day,” relying heavily on professional expertise, engineers used paper, pencils, and calculators to design complex systems to the best of their abilities before ultimately crossing their fingers, spending a lot of money, and installing the system. Once installed, if the design turned out to be a decent starting point, engineers could then embark on a tedious, and expensive, trial and error calibration process before “going live” with the system.

Today, a computer running a simulation software package is the preferred tool for reconciling system component specifications and optimizing a system design. The output of a simulation program can provide engineers with an optimum design and precise system configurations even before a dime of capital is spent. Convenience for the designer aside, simulation packages save untold amounts of capital by allowing designers to go through the iterative calibration processes and system schematic changes before any tangible component of the system is ever installed. Even though simulation packages, both simple and robust, are commonplace in today's world of engineers and designers, surprisingly there is no simulation package available to designers of wireless, non-cellular telecommunication networks.

There are, however, many coverage-planning applications for general cellular telecommunications technologies. Typical simulation applications for the design of cellular telecommunications networks are not suited for the design of Wi-Fi and other types of wireless networking systems because such applications are not capable of reconciling directionality and heterogeneity among radio transmission sources and amplifying antennae.

Cellular networks rely on equally spaced “cells” of fixed transmission radii that leverage very similar, if not identical, radio sources at the center or on the edge of each cell depending on the particular configuration. In a cellular network application, designer specification of signal sources, antennae, and aiming are trivial. Even topographical considerations, though considered in cellular network planning, are simplified by the homogeneity of technology comprised within each cell. Thus, for cutting edge wireless network designs with non-uniform components and varying coverage zones, existing cellular link and network coverage planning and simulation techniques are inadequate.

Planning, extending, or modifying a modern day wireless network is a time consuming and potentially error producing process. The seamless integration of myriad interdependent components is necessary in order to realize a target level of functionality. The inherent challenges to wireless network design are compounded by the fact that even a small network can contain hundreds of links and, therefore, the design process presents several core challenges to a wireless network planner. For each wireless link in a non-cellular network, a designer must skillfully correlate the varying topography over/through which each system link is to be deployed with design factors including, but not limited to:
1. Specification of signal emitting radios including the key characteristics of those radios and their software drivers;
2. Specification of antennae such that power amplification and effective range of each radio network link is optimized;
3. Specification of positioning for each wireless link endpoint;
4. Specification for the 3-dimensional calibration and “aiming” of each end of a radio link.

Clearly, there is a need in the art for a simulation application specifically suited for the planning, design and optimization of wireless telecommunication networks that encompass components of varying specifications applied across varying topographical considerations. The present disclosure describes embodiments for the fulfillment of such a need in the art, and other needs in the art, through a highly specialized software application capable of simulating the configuration of a modern day telecommunications network.

### BRIEF SUMMARY OF THE DISCLOSURE

The present disclosure provides, among other things, a solution to the above-described needs in the art, as well as other needs in the art, by providing a system and method to automate the design and optimization of a wireless telecommunications network. In general, some embodiments are described as utilizing a personal computer, server, or other device to design and optimize a wireless telecommunications network through algorithms embodied in a software application residing on the device. In certain embodiments or systems, the device charged with running the simulation software is communicatively coupled to a database containing technical specifications of various models of components used in a wireless telecommunications network, while other embodiments may have the database of network component technical specifications reside on the same device as does the simulation software. In still other embodiments, the algorithms used by the simulation software may be modifiable by a user, in other embodiments not. Also, some embodiments of the invention are operable to provide a user a graphical output via a graphical user interface.

The present disclosure describes at least one embodiment that provides the functionality to quickly and easily simulate configurations for various wireless telecommunications network components at hypothetical geographical locations in order to predict performance of potential wireless network links. Embodiments may also be operable to optimize component configurations and locations to predict optimum network footprints. To transform data associated with hypothetical geographical network link locations and wireless network component performance specifications, the exemplary systems may employ a series of specialized algorithms, or editors, to compile and simulate user provided configurations of all or certain key aspects of each wireless link in a theoretical network footprint. Once each wireless link, or network node, is configured by the relevant editor, the system simulates and predicts network performance via a simulation engine.

Typical editors that can be utilized in various implementations of the system include, but are not limited to:
Radio editor—allows the user to select external or internal antenna configurations, arbitrary operating frequency bands used for transmission, and antenna compatibility at each band.
Antenna editor—allows the user to specify operating characteristics of various antennae including frequency bands, range, and radio compatibility.
Location editor—allows the user to specify or manipulate geographical locations for transmission sources.

As stated earlier, in some embodiments the user can invoke a simulation engine once radios, antennae, and locations are configured via the editors for one or more network links. The simulation engine aspect of embodiments of the present invention is operable to iteratively run RF signal propagation, loss, and terrain analysis calculations, as well as other calculations, in order to assess the various user-specified combinations of locations, bands, radios, and antennas for each link. It should be appreciated that the specific calculations or analytical processes run on the simulation engine aspect of the system may vary with embodiments and, as such, the claims associated with this application represent the only limit on scope, not the particular combination of tasks performed by the simulation engine aspect of a given embodiment.

The embodiments and implementations, as well as variants thereof that are disclosed here dramatically improve the network planning and design process by increasing the efficiency at which a radio network planner can configure and evaluate complex wireless telecommunications network options. The aforementioned advantages, as well as other aspects, features and embodiments are presented in greater detail in the following description.

### BRIEF DESCRIPTION OF DRAWINGS

FIG. 1 is a block diagram illustrating the interconnectivity and components of an exemplary embodiment of a wireless network design simulation system.

FIG. 2 is a system diagram illustrating the high level architecture of at least one embodiment of the present invention that includes an empirical results database.

FIG. 3 is a flow diagram illustrating the typical logic of at least one embodiment of the present invention used to transform data input by a user into a simulation output representing a predicted performance for a proposed wireless network.

FIG. 4 is a sample simulation output, in map form, of one embodiment of the present invention.

### DETAILED DESCRIPTION

The present disclosure presents solutions to the above-described needs in the art, as well as other needs in the art, by providing a system and method to automate the design and optimization of a wireless telecommunications network. More specifically, the disclosed embodiments provide the functionality to quickly and easily simulate configurations for various wireless telecommunications network components at predetermined geographical locations in order to predict performance of potential wireless network links. Various embodiments are also able to optimize network component configurations and locations to predict optimum network footprints. To transform data associated with predetermined geographical network link locations and wireless network component performance specifications, an embodiment may employ a series of specialized algorithms, or editors, to compile and simulate user provided configurations of all key aspects of each wireless link in a theoretical network footprint. Once each wireless link, or network node, is configured by the relevant editor, the system simulates and predicts network performance via a simulation engine before providing the user with a representative output. Typical editors used by some embodiments include, but are not limited to, a radio editor, an antenna editor, and a geographic location editor.

As stated earlier, in some embodiments the user can invoke a simulation engine once radios, antennae, and locations are configured via the editors for one or more network links. The simulation engine aspect that may be incorporated into various embodiments is operable to iteratively run RF signal propagation, loss, and terrain analysis calculations, as well as other calculations, in order to assess the various user-specified combinations of locations, bands, radios, and antennas for each link. It should be appreciated that the specific calculations or analytical processes represented by the simulation engine aspect may vary with embodiments and, as such, the claims associated with this application represent the only limit on scope, not the particular combination of tasks performed by the simulation engine aspect of a given embodiment.

Again, the various embodiments described may dramatically improve the network planning and design process by increasing the efficiency at which a radio network planner can configure and evaluate complex wireless telecommunications network options. Prior to this invention, designers of wireless telecommunications networks relied solely on experience in order to select network components and specify initial configurations. Consequently, the initial quality of a network design varied from designer to designer as each had disparate component preferences, unique design techniques, and differing experience levels.

The disclosed systems and methods remedy differences and inconsistencies in network footprint design, component selection and configuration, and network performance that heretofore were inevitable among network designers. As a result, users can consistently produce efficient network designs with initial component selections and configurations that minimize upfront design time as well as initial network installation costs.

At the center of an exemplary embodiment is a series of editors capable of processing designer data inputs and identifying a best practice component selection and initial configuration setting for that component. While the editors, and the specific algorithms used by a given editor, are unique aspects, it should be understood that such elements are not required in all embodiments or implementations and as such, are provided as a non-limiting example. In fact, embodiments may, or may not, encompass an editor aspect at all. Further, the types of editors, the algorithms and calculations run by editors, or the use of an editor output by a simulation engine aspect is also provided as a non-limiting example of a certain class of embodiments. Typical editors used in some embodiments and in various combinations, are elaborated on in this detailed description for illustrative and enabling purposes only. Thus, it should be appreciated that the various embodiments are not limited to any particular combination or presence of specific editors, although particular editors may give rise to particular novel aspects of the present invention.

In general, at least one implementation of the disclosed system or method employs editors operable to transform user data inputs into a best practice selection and recommended configuration of network components including radios and antennae. An exemplary antenna editor may allow a user to add, edit, and delete antennas from the model network by extracting associated antenna specifications and potential configurations from a relational database. Incidentally, the database of component specifications and configurations, whether associated with antennae, radios or some other telecommunications network component, may reside on a user's computer, a local server, a web based server or other device. Further, the database of component specifications and configurations may be operable to be automatically updated with new or modified component specifications and recommended configurations via the Internet, compact disc, or other means known to those skilled in the art. The particular location or characteristics of the comprehensive data stored in the aforementioned database, however, is not in anyway limiting but rather is provided as a non-limiting example. In fact, as an alternative, a given editor aspect in some embodiments may not even require that a database be communicatively coupled to the system as the data input to the editor could conceivably originate entirely from the user or some other source.

Within an exemplary antennae editor interface, the user selects a specific antenna model along with arbitrary frequency bands at which the given antenna should operate. Next, for each specified frequency band, the user can indicate the antenna's gain in decibels isotropic (dBi), a relative gain measurement with respect to an isotropic radiator (antenna) in free space. Further, some radio editor aspects may also be operable to specify the radios that are known to be compatible with the user selected antenna, even though the primary specification of radio-antenna compatibility is made in the radio editor for typical embodiments.

Similar to a typical antenna editor aspect, an exemplary radio editor enables a user to add, edit, and delete radios from the model system. As explained prior with respect to antennae, the specifications and configuration settings associated with radios may also be stored in a relational database. Within a typical radio editor user interface, the user selects a radio model, specifies its operation with either external or internal antennae, and designates arbitrary frequency bands for its operation. Next, for each selected frequency band, the user specifies the transmission power for the designated radio in logarithmic units of decibels with respect to one milliwatt (dBm). Further, if the radio is to be configured such that it uses an internal antenna, the gain in dBi of the internal antenna may be specified by the user in the radio editor. Alternatively, if the user designates that a radio be associated with the use of external antennae, an exemplary radio editor may enable the user to select the specific antennas that are compatible with the designated radio at each frequency band. In some embodiments, external antenna specifications may be selected from a database of antennas previously determined via an antenna editor.

Also included in an exemplary embodiment of the present invention is an editor used to select the geographic locations of towers in a proposed network footprint. Those skilled in the art will appreciate that although the term tower may refer to a free standing tower for mounting of antennas or other equipment, that the term tower may also apply to any mounting point including the side of a building, the top of a light pole, a rooftop, church steeple, tall tree, etc. Some embodiments may employ a form-based location editor while others may use a map-based location editor. For a typical form-based location editor, the user may create, edit, delete and save new or existing test locations from the database of available tower locations associated with a proposed network. Using the interface of a form-based location editor, the user names each tower location and specifies its unique known characteristics, if no characteristics are already associated with the given location in the aforementioned database, such as latitude, longitude, and tower height. The user interface and database associated with a form-based location editor feature may be provided through a PC based application, a web based application, or otherwise. Regardless, the particular location, method of access, or means of input are not limiting characteristics of the form-based location editor aspect as various modes of implementation will be known to those skilled in the art. For exemplary purposes only, a current embodiment that encompasses a form-based location editor provides the interface through a web-based form over the intranet or Internet.

As an alternative to the form-based location editor, some implementations may employ a map-based location editor. Much like in a form-based location editor, an exemplary map-based location editor enables the user to create, edit, delete and save new or existing test locations from the database of available tower locations associated with a proposed network. The map-based version of the location editor differs from the form-based version, however, in that the interface for an exemplary map-based location editor provides the user a visual depiction of the terrain over which the proposed network may be installed. Using the map-based interface, the user can make “point and click” selections on the map to add a new tower location, rename existing location markers, edit location characteristics, delete locations, or unlock the map for “drag and drop” of existing location markers to new placements. As described prior in relation to the form-based version of the location editor aspect, user selections in the map-based location editor are saved in a database associated with the proposed network design.

In addition to the exemplary map-based location editor described above, other editor aspects may also make use of graphical user interface (GUI) features known to those skilled in the art. Convenient features such as the “point & click” described above as well as drop down type menus, hyperlinks, virtual buttons, auto-correct and format capabilities, and other common GUI features are known to those skilled in the art of software interface and, while such features may be novel in and of themselves, should not be considered to be required or limiting features.

Regardless of the specific formats, capabilities, or presence of given editors, disclosed systems and methods may include a simulation engine operable to compile user input data and selections, whether derived manually or from an editor aspect, into a virtual telecommunications network simulation. In fact, it should be appreciated that the simulation engine itself could be operable to automatically make initial component selections without the requirement of manual user inputs or editor interface.

The simulation engine provides a recursive interface to an underlying network link simulator for each link between network nodes, or towers equipped with virtual radios and antennas, defined by the user in the initial simulation setup. Using predefined rules and scenarios to manipulate the user input data, the simulation engine applies algorithms and calculates the predicted performance of each network node and, subsequently, the overall predicted performance of the proposed network.

Advantageously, the simulation engine automatically generates the required input runs for each theoretical network link and extracts the essential data from the resulting output before iteratively evaluating the next link in the network. For each network node, the simulation engine may be operable to specify the “aiming” of each end of the specific radio link in order to maximize node performance. Radio link “aiming” may be limited by the antenna types previously chosen by the user and so some versions of the simulator engine may be capable of modifying the selected antenna for a given link or proposing alternative antenna designs to the user.

As an example of considerations stemming from antenna selection, an omni-directional antenna may cover a 360° horizontal spread whereas a sector antenna may cover a smaller arc encompassing only a 120° horizontal spread. Regardless, because antennae typically only transmit thorough a limited arc of coverage on the vertical axis, for instance 5° up and down, the tower height and antenna tilt from level affect the performance of a given network link. The simulation engine, using predetermined rules and scenarios, can calculate the optimum configuration of all components in the link. In addition to suggesting antenna configuration, the simulation engine may be operable to determine optimum power levels for network nodes anticipating coverage areas with varying population densities or non-uniform population distribution. In these ways, the simulation engine dramatically simplifies and expedites the individual link and overall network planning and testing processes.

To invoke an exemplary simulation engine, a user determines which network nodes, or portion of the proposed network, to simulate. Next, the user selects the frequency bands to test for each possible link in the selected location set as well as the chosen radios for each possible band and link combination. Finally, the user selects which antennas to evaluate for each possible radio-band-link combination. From those inputs, the simulation engine is operable to automatically promulgate the necessary simulation steps for each link. For some embodiments, a simulation storage management aspect provides the means for the output data from the simulation engine to be saved in a database for future reference. Additionally, embodiments may afford the user to download a simulation output as a text file or present it in a map overlay that can be displayed graphically on a map interface.

As an example of a map overlay output, an embodiment could employ Google Earth *.kml overlay files for integration with Google maps. Additionally, the link simulation algorithms embodied in the simulation engine aspect may be of an open source such as SPLAT!. Google Earth overlay files and SPLAT! link simulation algorithms are offered for illustrative purposes only and are not intended to be limiting factors. Those skilled in the art will recognize other map engines and radio link/path simulation tools that could be employed by the present invention.

Some embodiments may have a database of empirical data captured from the monitoring of actual performance on existing networks. In such an embodiment, the system is communicatively coupled to an existing telecommunications network through a data network. As the system runs, it monitors the real-time performance of the network and logs relevant data into a database of empirical scenarios. Because the component specifications, configurations, topographical characteristics of links, and system load is known to the system, the captured data can be used to calibrate the projected performance of a proposed network against the actual performance of an existing network. In this way, the accuracy of subsequent simulations can be incrementally improved as more and more “real” data is made available. Examples of data that may be relevant in evaluating the performance of an actual network link include, but are not limited to, vegetation density, population density, presence of adjacent structure and its material of construction, or varying environmental conditions.

It is anticipated that embodiments may be operable to share empirical results across running instances of the invention. Advantageously, the sharing of empirical data across running instances would facilitate the growth of relevant knowledge bases and, subsequently, more and more accurate network simulations. Additionally, modifications and updates to base rules or scenarios may also be shared across running instances in some embodiments.

An empirical knowledge base, taken in conjunction with theoretical simulation results, can be used in some embodiments to provide automated suggestions to users as cases with special circumstances arise. More specifically, an empirical and theoretical rules and scenarios database can be leveraged by some embodiments to provide a semi-automated “wizard” aspect useful to guide lesser-experienced users through the processing of each network, site, and link. Further, the knowledge and rules employed can be combined to provide fully automated RF planning from a canonical set of inputs including, but not limited to:
3-dimensional geographical locations for routers and antennae
Topographical information associated with network links
Materials of construction associated with known link obstructions
Common environmental conditions associated with network links
RF noise in tower site and its surrounds
Empirical information from past links, sites, and networks available to the system which may include information generated by other instances of the tool around the globe that are shared with the present instance
Rules and special cases that are encoded in the present instance at the present location or acquired through a sharing mechanism from other instances.

Now turning to the figures in which like labels refer to like elements, various embodiments, aspects and features of the system and method are more fully described.

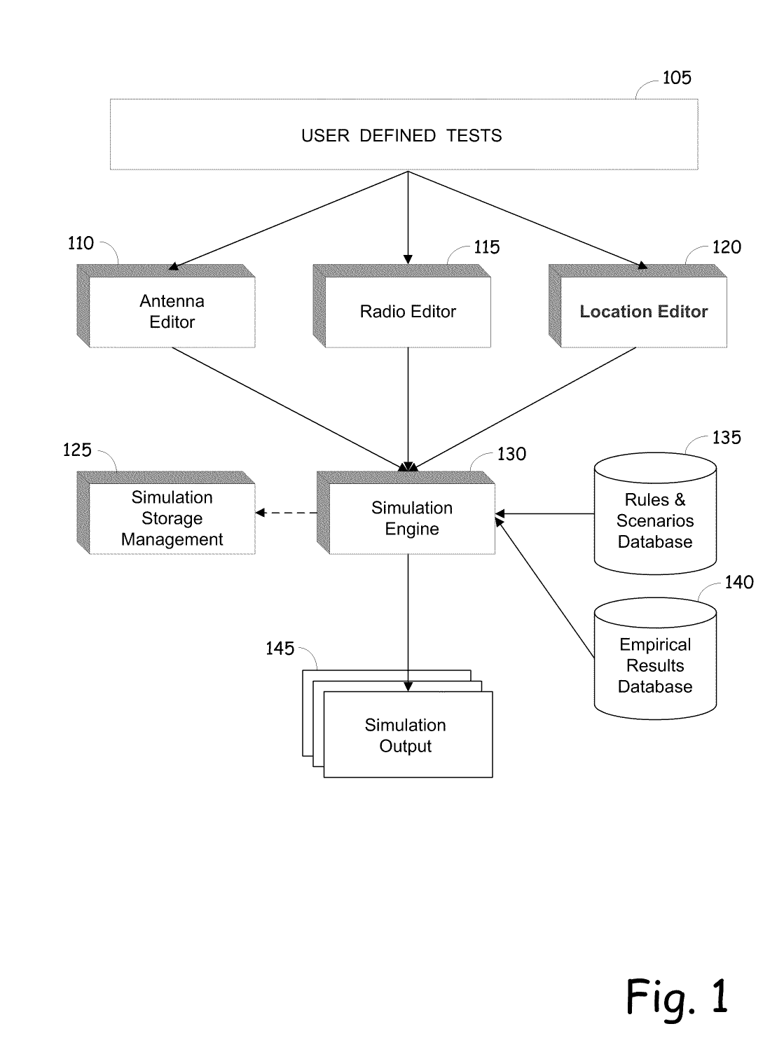

FIG. 1 is a block diagram illustrating the interconnectivity and components of an exemplary embodiment of a wireless network design simulation system. Initially, the network planner, or user, defines the specific tests and component selections 105 and inputs the associated data into the relevant editors 110, 115, and 120. In a typical wireless network design simulation system, the user employs specific editors for major components of the proposed network. The antenna editor 110 is operable to accept user inputs for initial antenna models and setup configurations. Similar to the antenna editor 110, the radio editor 115 is operable to accept user inputs for initial radio models and setup configurations. The location editor 120 accepts topographical and terrain considerations associated with specific proposed network links.

The data associated with user selections in the editors 110, 115, 120 are compiled by the simulation engine 130. The simulation engine 130 applies predictive algorithms derived from the rules and scenarios database 135 in order to predict the performance of a proposed network based on the editor 110, 115, 120 inputs. Additionally, some systems may also provide the simulation engine with empirical data 140 taken from existing networks to modify the rules and scenarios 135.

Once the simulation engine 130 has generated a predicted network performance, the simulation may be saved in a simulation storage management module 125 and a simulation output 145 provided directly to the system user.

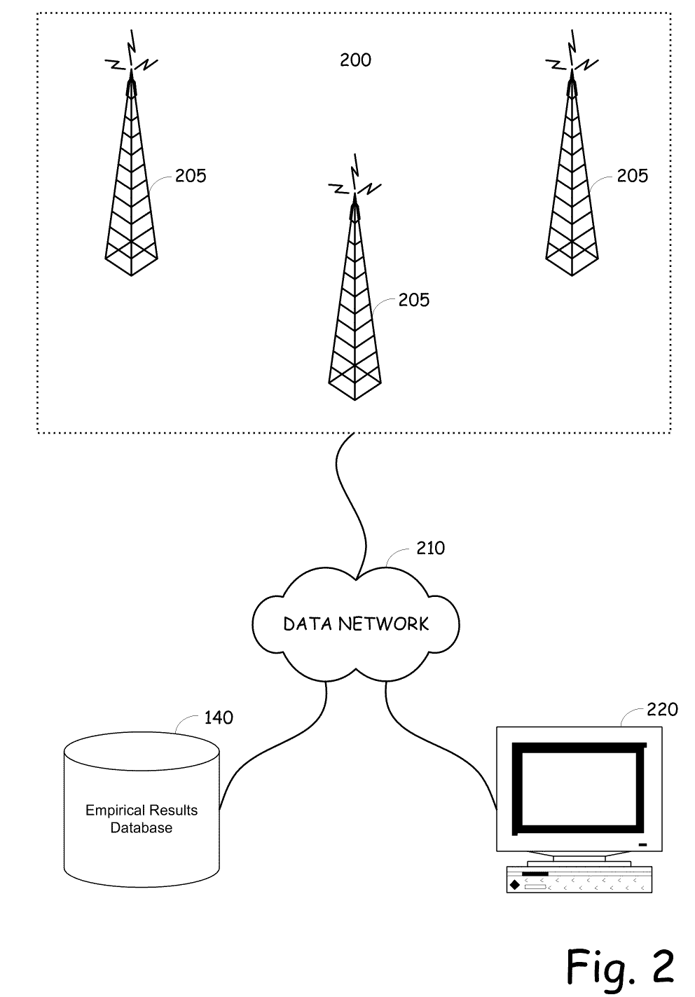

Turning now to FIG. 2, a system diagram illustrating the high level architecture of at least one embodiment of network design simulation system that includes an empirical results database 215 is depicted. Some embodiments have an empirical results database 215 that is communicatively coupled through a data network 210 to an existing wireless telecommunications network 200. The existing telecommunications network 200 consists of at least two towers 205. Actual performance data associated with specific links in the existing network 200 between towers 205 can be associated with known component specifications, setup configurations, and environmental considerations for specific network links. The data collected can be stored in an empirical results database 215 and subsequently incorporated by the simulation engine running on a given instance 220 of the present invention in an effort to improve simulation accuracy.

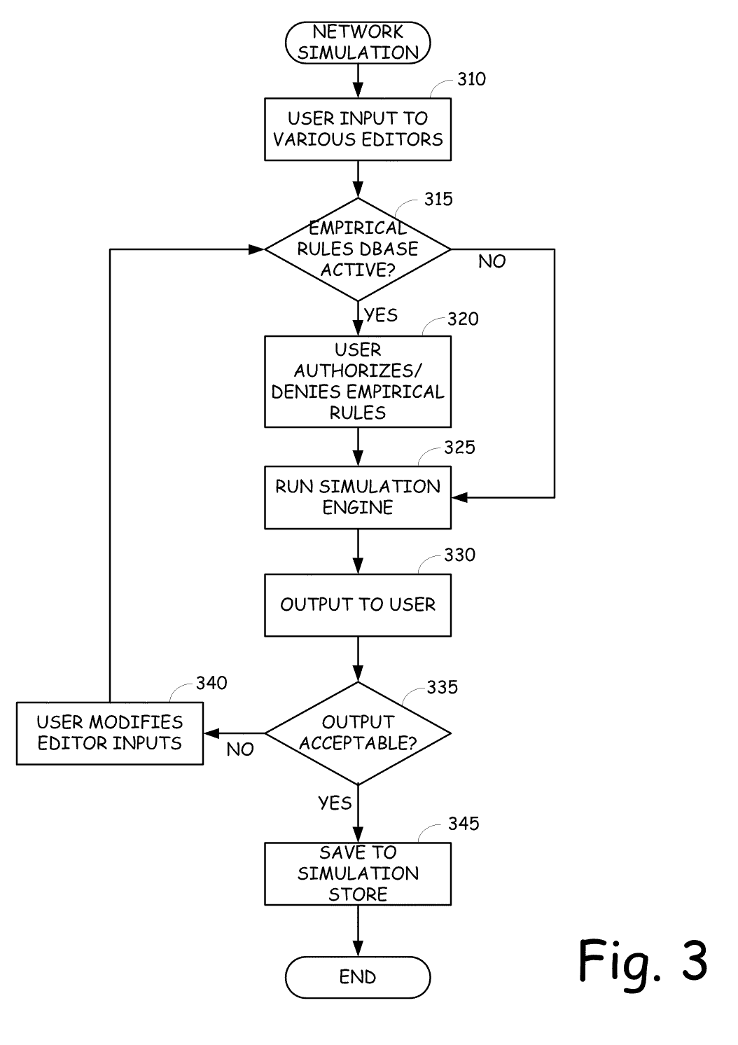

FIG. 3 is a flow diagram illustrating the typical logic of at least one network design simulation system used to transform data input by a user into a simulation output representing a predicted performance for a proposed wireless network. While some embodiments may not even have editor aspects, the method of FIG. 3 is illustrative of steps taken by an exemplary embodiment that includes at least one editor.

At the initial step of the method, a user interfaces with various editors 310 by selecting component specifications, specifying initial configurations, and may even input factors associated with known topographical considerations. Some embodiments may employ an empirical rules database aspect 140, as described prior. In the exemplary method of FIG. 3, if the empirical rules database 140 is active then the user is prompted to authorize 320 the empirical rules database 140 as an override to the standard rules and scenarios 135 associated with the given instance of the invention. If the empirical rules database 140 is not active 315, then the simulation engine 130 proceeds to compile a simulation 325, as described prior, according to the user defined tests 105 and the standard rules and scenarios database 135.

Once the simulation engine 130 produces a simulation output 145, the simulation output 145 is made available 330 to the user. If the user finds the output acceptable 335, then the simulation output 145 is stored 345 in the simulation storage management aspect 125. If, however, the output 145 is not acceptable 335 to the user, then the user modifies 340 the user defined tests 105 and the method repeats beginning with the determination 315 of an active empirical rules database 140.

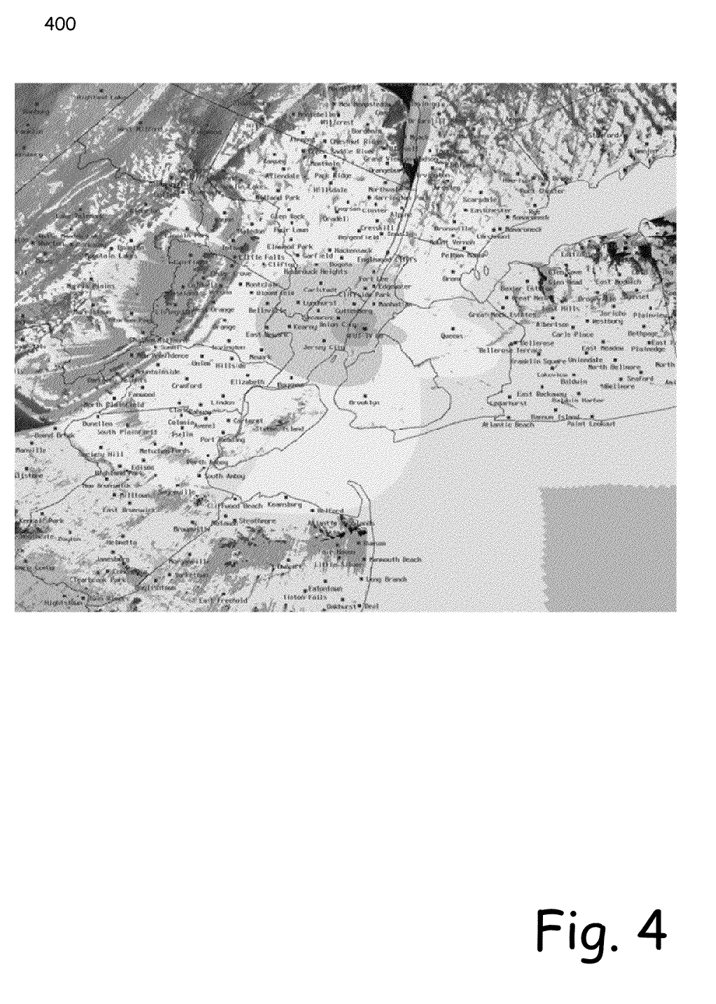

FIG. 4 is a sample simulation output 400, in map form, of one embodiment of the present invention. As described prior, the simulation output may be in the form of a text file or a map overlay that can be displayed graphically on a map interface. Other formats for simulation outputs will be known to those skilled in the art. Here, the exemplary simulation output 400 is derived from a Google Earth *.kml map overlay file that is displayed graphically on a map interface provided by Google maps.

Although the various embodiments have been described primarily in view of outdoor networks, it will also be appreciated that various embodiments may also work with indoor networks as well as hybrid networks that include a combination of components spanning both outdoor and indoor areas. Embodiments that focus on indoor networks or that are inclusive of indoor sub-networks or components may include accounting for signal loss/penetration through walls and other obstacles.

In the description and claims, each of the verbs, “comprise” “include” and “have”, and conjugates thereof, are used to indicate that the object or objects of the verb are not necessarily a complete listing of members, components, elements or parts of the subject or subjects of the verb.

Embodiments have been described by detailed descriptions of various features thereof that are provided by way of example and are not intended to limit the scope of the disclosure. It will be appreciated that other uses of disclosed embodiments are also anticipated. The described embodiments comprise different features, not all of which are required in all embodiments. Some embodiments utilize only some of the features or possible combinations of the features. The scope of the disclosure is limited only by the following claims.

What is claimed is:

1. A system for predicting wireless telecommunication network performance using a knowledge base of rules and a database derived from known network component performance and compatibility specifications, the system comprising:
means for receiving component selection and initial component configuration settings for all components associated with a telecommunications network node, component selection including antenna model and radio model;
means for receiving geographical location coordinates for said network nodes;
means for generating predictive performance data associated with telecommunications network links between geographically adjacent said network nodes, the predictive performance data being calculated by applying rules in said knowledge base to component performance and compatibility specifications in said database; and
means for generating a simulation output representative of said predictive performance data associated with said network links.

2. The system of claim 1, wherein the means for generating predictive performance data is further operable to generate data representative of the overall simulated network performance, in addition to predictive performance data relative to individual network links.

3. The system of claim 1, further comprising:
means for receiving tower height data associated with a given network node; and
wherein the means for generating predictive performance data associated with network links between geographically adjacent network nodes, the predictive performance data being calculated by applying rules in said knowledge base to component performance and compatibility specifications in said database, is further operable to consider tower height in the predictive performance calculation.

4. The system of claim 1, further comprising:
means for receiving environmental considerations data associated with a given network link; and
wherein the means for generating predictive performance data associated with network links between geographically adjacent network nodes, the predictive performance data being calculated by applying rules in said knowledge base to component performance and compatibility specifications in said database, is further operable to consider said environmental considerations data in the predictive performance calculation.

5. The system of claim 1, further comprising a means to recommend alternate component selections.

6. The system of claim 1, further comprising a means to recommend alternate component settings and configurations.

7. The system of claim 1, further comprising at least one editor means, communicatively coupled to said means for receiving component selection and initial component configuration settings for all components associated with a network node, wherein a user interface is provided for data input specific to a given network component.

8. The system of claim 1, further comprising a means, communicatively coupled to said means for generating a simulation output representative of said predictive performance data associated with network links, for storage and retrieval of simulation outputs.

9. The system of claim 1, wherein said means for generating a simulation output representative of said predictive performance data associated with said network links is operable to deliver said simulation output in the form of a text file.

10. The system of claim 1, wherein said means for generating a simulation output representative of said predictive performance data associated with said network links is operable to deliver said simulation output in the form of a graphical map.

11. A system operable to plan, design, evaluate, and optimize wireless telecommunication networks, the system comprising:
a database of known network component performance and compatibility specifications;
a knowledge base defining rules of calculation for a predicted performance of a simulated wireless telecommunications network;
at least one editor function, communicatively coupled to said database of known network component performance and compatibility specifications, operable to provide an interface with a user for the selection and input of data associated with specific families of network components; and
a simulation engine, communicatively coupled to any said editors and said knowledge base of rules, operable to generate predictive performance data of proposed network links between geographically adjacent network nodes and a representative output, the predictive performance data being calculated by applying rules in said knowledge base to component performance and compatibility specifications provided through said editors.

12. The system of claim 11, further comprising a simulation storage management component, communicatively coupled to said simulation engine, operable to store simulation engine outputs.

13. The system of claim 11, further comprising:
a database of empirical results captured from the monitoring of an existing wireless telecommunications network; and
wherein said simulation engine, communicatively coupled to said database of empirical results, is further operable to modify said knowledge base of rules based on input from said database of empirical results.

14. The system of claim 13, wherein said database of empirical results is communicatively coupled to an existing wireless telecommunications network and operable to be continuously updated.

15. The system of claim 13, wherein said database of empirical results is communicatively coupled to multiple said simulation engines.

16. They system of claim 13, wherein said simulation engine is further operable to exclude said empirical results.

17. The system of claim 11, wherein said at least one editor function operable to provide an interface with a user for the selection and input of data associated with specific families of network components features a graphical user interface.

18. The system of claim 11, wherein said database of known network component performance and compatibility specifications is operable to be automatically updated.

19. The system of claim 11, wherein said knowledge base defining rules of calculation for a predicted performance of a simulated wireless telecommunications network is operable to be automatically modified.

20. A method for predicting wireless telecommunication network performance, the method comprising the steps of:
selecting all components associated with a telecommunications network node, component selection including antenna model and radio model;
selecting geographical location coordinates for said network nodes;
designating tower height data associated with a given network node;
designating environmental considerations data associated with a given network link;
determining initial configuration settings for selected components;
deriving predictive performance data for telecommunications network links between geographically adjacent network nodes by compiling data associated with user selections and designations through the application of a predetermined knowledge base of rules.
generating a simulation output representative of said predictive performance data associated with said network links.
